(19) United States
(12) Patent Application Publication
(10) Pub. No.: US 2018/0049209 A1
(43) Pub. Date: Feb. 15, 2018

(54) Quality of Service Control and Usage Monitoring Mechanisms for Unlicensed Access

(71) Applicant: Apple Inc., Cupertino, CA (US)

(72) Inventors: Haijing Hu, Beijing (CN); Dawei Zhang, Saratoga, CA (US); Huarui Liang, Beijing (CN)

(21) Appl. No.: 15/027,492

(22) PCT Filed: Feb. 5, 2016
(86) PCT No.: PCT/CN2016/073605

§ 371 Date: Apr. 6, 2016

(51) Int. Cl. H04W 72/08; H04W 48/08; H04W 92/02; H04W 24/10; H04W 48/18

(52) U.S. Cl. CPC H04W 72/08; H04W 24/10; H04W 48/18; H04W 92/02; H04W 48/08; H04W 76/046

(57) ABSTRACT

This disclosure relates to techniques for managing and monitoring access to a cellular network using unlicensed spectrum. According to some embodiments, policy information indicating permissible and/or non-permissible uses of unlicensed spectrum to access a radio access network of the cellular network may be distributed to elements of the radio access network, such as base stations. A base station establishing a radio bearer with a wireless device may receive information regarding a service type associated with the radio bearer and may determine radio bearer characteristics, potentially including whether to establish the radio bearer using unlicensed or licensed spectrum, based at least in part on the service type associated with the radio bearer and the network policy information. The base station and/or the user device may also report information regarding unlicensed (and possibly also licensed) network access by the user device to a core network of the cellular network.

### FIELD

The present application relates to wireless communication systems, including techniques for managing quality of service and monitoring usage of unlicensed access.

### DESCRIPTION OF THE RELATED ART

Wireless communication systems are rapidly growing in usage. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), IEEE 802.16 (WiMAX), Bluetooth, and others.

Some wireless communication techniques may be capable of using unlicensed frequency bands as a medium for the wireless communication; some may alternatively or additionally be capable of using licensed frequency bands. In some instances, wireless service providers may be capable of providing wireless access mechanisms using either unlicensed or licensed spectrum. The characteristics of such different access mechanisms may differ substantially, but techniques for controlling and monitoring their usage remain relatively undeveloped. Accordingly, improvements in the field would be desirable.

### SUMMARY

Embodiments are presented herein of apparatuses, systems, and methods for managing quality of service and monitoring usage of unlicensed access provided alongside licensed access.

According to the techniques presented herein, it may be possible for a cellular network to implement a policy governing unlicensed access to the cellular network, such as by way of license assisted access (LAA) communication using a cellular communication technique (e.g., LTE, LTE-A, etc.) or by way of Wi-Fi communication with a wireless access point. For example, a cellular network function within a policy control and charging (PCC) entity may be defined and may store and distribute policy information regarding unlicensed access to the cellular network.

Such a policy may specify types of data exchange that may (and/or may not) be performed using unlicensed access to the cellular network, and may be configured as desired by the network operator. As one possibility, a unlicensed network access policy might limit certain service types from performing data exchanges with the cellular network using unlicensed frequency bands; for example, certain services that require or desire higher quality of service (QoS) standards than can be guaranteed using unlicensed access may not be permitted on unlicensed frequency bands.

The policy information may be distributed to cellular base stations and/or wireless devices operating within the network. The policy information may then be used by the cellular base stations and/or wireless devices to determine how to establish data flows; for example, a radio bearer for a service may be set up to use an unlicensed frequency band, a licensed frequency band, or both licensed and unlicensed frequency bands depending at least in part on whether the service type of the service is permitted to use unlicensed network access according to the policy.

Additionally, according to some embodiments, unlicensed network access by wireless devices within the cellular network may be monitored by the cellular network. For example, a wireless device and/or a base station serving the wireless device may provide indications (e.g., to a core network entity of the cellular network) relating to when the wireless device accesses the network using unlicensed spectrum (and possibly also when the wireless device accesses the network using licensed spectrum). Such information may be used by the network for charging purposes, among various possibilities, for example to allow the possibility to define different charging rates for licensed and unlicensed access to network users.

The techniques described herein may be implemented in and/or used with a number of different types of devices, including but not limited to cellular base stations, access point devices, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings, in which:

FIG. 1 illustrates an exemplary (and simplified) wireless communication system, according to some embodiments;

FIG. 2 illustrates an example base station (BS) in communication with an example user equipment (UE) device, according to some embodiments;

FIG. 3 illustrates an exemplary block diagram of a UE, according to some embodiments;

FIG. 4 illustrates an exemplary block diagram of a BS, according to some embodiments;

FIGS. 5-7 are flowchart diagrams illustrating exemplary methods for implementing an unlicensed access policy and monitoring unlicensed access in a cellular network, according to some embodiments;

FIGS. 8-11 illustrate several possible example scenarios in which license assisted access to unlicensed spectrum can be provided in a cellular network, according to some embodiments;

FIG. 12 illustrates an example scenario in which LTE-WLAN aggregation can be provided in a cellular network, according to some embodiments;

FIG. 13 illustrates an example policy control and charging entity of a cellular core network that includes a license assisted access function, according to some embodiments; and

FIGS. 14-21 are signal flow diagrams illustrating exemplary aspects of possible techniques for implementing an unlicensed access policy and monitoring unlicensed access in a cellular network, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory computer accessible memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system that connects to the first computer system over a network, such as the Internet. In the latter instance, the second computer system may provide program instructions to the first computer for execution. The term “memory medium” may include two or more memory mediums that may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices that are mobile or portable and that performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) that is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

IEEE 802.11—refers to technology based on IEEE 802.11 wireless standards such as 802.11a, 802.11.b, 802.11g, 802.11n, 802.11-2012, 802.11ac, and/or other IEEE 802.11 standards. IEEE 802.11 technology may also be referred to as “Wi-Fi” or “wireless local area network (WLAN)” technology.

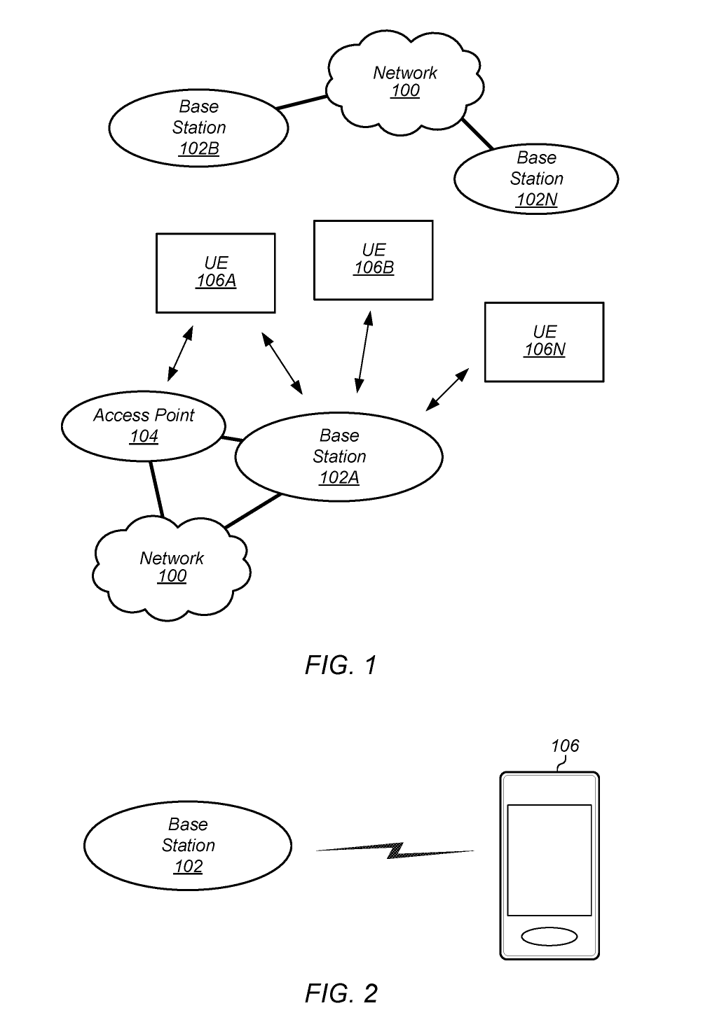

### FIGS. 1 and 2—Communication System

FIG. 1 illustrates an exemplary (and simplified) wireless communication system in which aspects of the present disclosure may be implemented, according to some embodiments. It is noted that the system of FIG. 1 is only one example of a possible system, and embodiments may be implemented in any of various systems, as desired.

As shown, the exemplary wireless communication system includes a base station 102A, which can communicate over a transmission medium with one or more user devices 106A, 106B, etc., through 106N. Each of the user devices may be referred to herein as a “user equipment” (UE). Thus, the user devices 106 are referred to as UEs or UE devices.

The base station 102A may be a base transceiver station (BTS) or cell site (a “cellular base station”), and may include hardware and/or software that enables wireless communication with the UEs 106A through 106N. The base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication among the user devices and/or between the user devices and the network 100.

The communication area (or coverage area) of a base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (WCDMA, TD-SCDMA), LTE, LTE-Advanced (LTE-A), 3GPP2 CDMA2000 (e.g., 1×RTT, 1×EV-DO, HRPD, eHRPD), Wi-Fi, WiMAX, etc. According to some wireless communication technologies, a base station may be able to provide a cell using licensed and/or unlicensed spectrum. For example, license assisted access (LAA) techniques may be used to provide a cell on unlicensed spectrum in conjunction with a cell provided on licensed spectrum.

Additionally, one or more access points (such as access point 104) may be communicatively coupled to the network 100, and may be within communicative range of one or more UEs 106 (e.g., UE 106A, as shown). These may include Wi-Fi access points configured to support cellular network offloading and/or otherwise provide wireless communication services as part of the wireless communication system illustrated in FIG. 1. Such access points may be collocated with a cellular base station or may be deployed separately from any cellular base stations, as desired. In some instances (e.g., for network-deployed access points), such an access point may have a backhaul communication reference point with a base station, such as illustrated between access point 104 and base station 102A.

Base station 102A and other similar base stations (such as base stations 102B . . . 102N) and/or access points (such as access point 104) operating according to the same or a different wireless communication standard may thus be provided as a network of cells, which may provide continuous or nearly continuous overlapping service to UEs 106A-N and similar devices over a geographic area via one or more wireless communication standards, potentially using either or both of licensed and unlicensed spectrum.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations) and/or wireless local area networks (WLANs), which may be referred to as “neighboring cells” or “neighboring WLANs” (e.g., as appropriate), and/or more generally as “neighbors”. Such neighbors may also be capable of facilitating communication between user devices and/or between user devices and the network 100. Such neighbors may include “macro” cells, “micro” cells, “pico” cells, “femto” cells, WLANs, and/or cells that provide any of various other granularities of service area size. For example, base stations 102A-102B illustrated in FIG. 1 might provide macro cells, base station 102N might provide a micro cell, and access point 104 might be a Wi-Fi AP that provides a WLAN. Other configurations are also possible.

Note that a UE 106 may be capable of communicating using multiple wireless communication standards. For example, a UE 106 might be configured to communicate using two or more of GSM, UMTS, CDMA2000, WiMAX, LTE, LTE-A, WLAN, Bluetooth, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible.

FIG. 2 illustrates user equipment 106 (e.g., one of the devices 106A through 106N) in communication with a base station 102 (e.g., one of the base stations 102A through 102N), according to some embodiments. The UE 106 may be a device with cellular communication capability such as a mobile phone, a hand-held device, a wearable device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate RF and/or digital radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 might include a shared radio for communicating using either of LTE or 1×RTT (or LTE or GSM), and separate radios for communicating using each of Wi-Fi and Bluetooth. Other configurations are also possible.

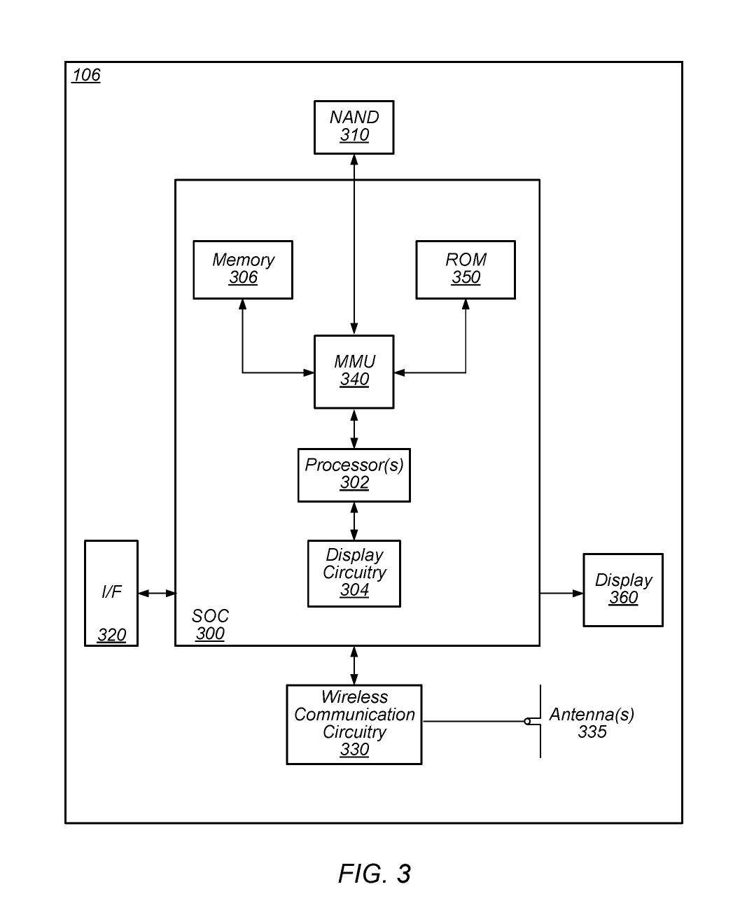

### FIG. 3—Exemplary Block Diagram of a UE

FIG. 3 illustrates an exemplary block diagram of a UE 106, according to some embodiments. As shown, the UE 106 may include a system on chip (SOC) 300, which may include portions for various purposes. For example, as shown, the SOC 300 may include processor(s) 302 that may execute program instructions for the UE 106 and display circuitry 304 that may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, CDMA2000, Bluetooth, Wi-Fi, GPS, etc.).

As shown, the UE device 106 may include at least one antenna (and possibly multiple antennas, e.g., for MIMO and/or for implementing different wireless communication technologies, among various possibilities), for performing wireless communication with base stations, access points, and/or other devices. For example, the UE device 106 may use antenna(s) 335 to perform the wireless communication.

The UE 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving/interpreting user input.

As described further subsequently herein, the UE 106 may include hardware and software components for implementing part or all of the methods described herein. The processor 302 of the UE device 106 may be configured to implement part or all of the methods described herein, e.g., by executing program instructions stored on a memory medium (e.g., a non-transitory computer-readable memory medium). In other embodiments, processor 302 may be configured as a programmable hardware element, such as an FPGA (Field Programmable Gate Array), or as an ASIC (Application Specific Integrated Circuit). Alternatively (or in addition) the processor 302 of the UE device 106, in conjunction with one or more of the other components 300, 304, 306, 310, 320, 330, 335, 340, 350, 360 may be configured to implement part or all of the features described herein.

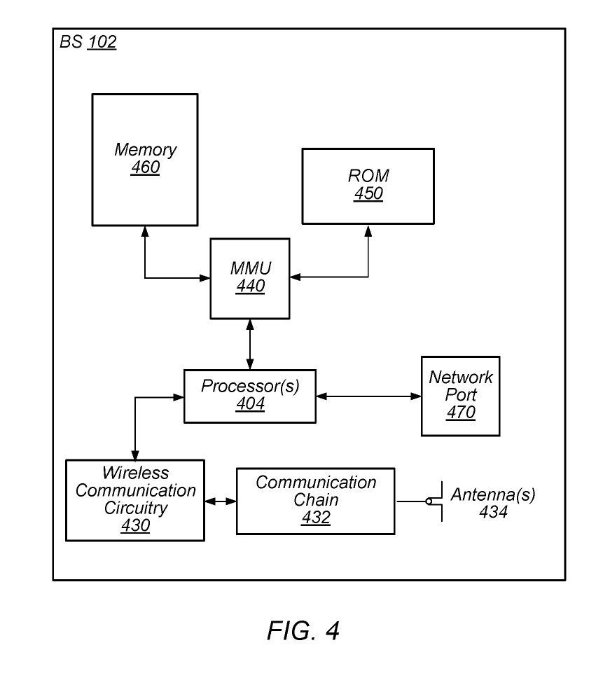

### FIG. 4—Exemplary Block Diagram of a Base Station

FIG. 4 illustrates an exemplary block diagram of a base station 102, according to some embodiments. It is noted that the base station of FIG. 4 is merely one example of a possible base station. As shown, the base station 102 may include processor(s) 404, which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the wireless communication circuitry 430 via communication chain 432. Communication chain 432 may be a receive chain, a transmit chain or both. The radio 430 may be configured to communicate via various wireless telecommunication standards, including, but not limited to, LTE, LTE-A, GSM, UMTS, CDMA2000, Wi-Fi, etc.

The BS 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a Wi-Fi radio for performing communication according to Wi-Fi. In such a case, the base station 102 may be capable of operating as either or both of an LTE base station and a Wi-Fi access point. As another possibility, the base station 102 may include a multi-mode radio that is capable of performing communications according to any of multiple wireless communication technologies (e.g., LTE and Wi-Fi, LTE and UMTS, etc.).

The BS 102 may include hardware and software components for implementing part or all of the methods described herein. The processor 404 of the base station 102 may be configured to implement part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement part or all of the features described herein.

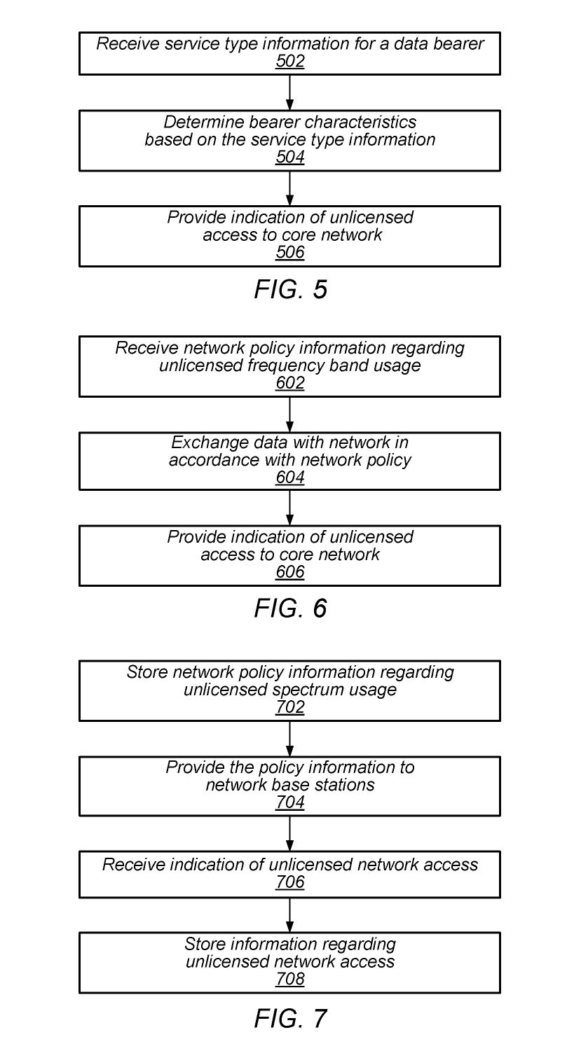

### FIGS. 5-7—Flowchart Diagrams

As previously noted, it is increasingly common for wireless devices to be equipped with the capability to communicate using multiple wireless communication technologies. For example, many smart phones are able to communicate using both IEEE 802.11 wireless local area networking (WLAN) and 3GPP (LTE/UMTS/GSM) and/or 3GPP2 (CDMA2000/cdmaOne) cellular radio interfaces, such that a user of such a device may be able to use a cellular data connection simultaneously with a WLAN connection.

Furthermore, increasingly small cells with collocated WLAN/cellular interfaces are being deployed by cellular network operators. In such cases, operator provided WLAN access points may be used for traffic offloading, for example with 3GPP traffic offloading and interworking mechanisms between cellular and WLAN base stations and access points. Such integrated cellular and WLAN dual connectivity may allow for the possibility of using either or both of licensed spectrum (e.g., using cellular communication techniques) and unlicensed spectrum (e.g., using 802.11 communication techniques).

Use of cellular communication techniques on unlicensed spectrum may also be possible, in addition or as an alternative to cellular-WLAN interworking techniques, in many cellular network deployment scenarios. For example, license assisted access (LAA) techniques for utilizing unlicensed spectrum in conjunction with licensed spectrum usage according to 3GPP standards including LTE are gaining increasing attention.

Providing the possibility for both unlicensed and licensed network access may have the potential to improve any or all of user throughput, Quality of Service (QoS), and network utilization/radio resource efficiency, among various possibilities. However, it may be worthwhile for a system offering both unlicensed and licensed network access to carefully craft its policies regarding usage of such unlicensed and licensed network access, e.g., in view of the potentially differing characteristics of licensed and unlicensed spectrum, and of the mechanisms by which such unlicensed and licensed network access can be achieved. For example, unlicensed spectrum may be subject to interference (e.g., from competing uses of such spectrum) to which licensed spectrum may not be subject. As another example, Wi-Fi communication may differ in character than cellular communication, and even cellular communication formulated for use on unlicensed spectrum (such as LTE-LAA communication) may differ in character than cellular communication formulated for use on licensed spectrum (such as typical LTE communication).

Accordingly, FIGS. 5-7 are flowchart diagrams illustrating methods for providing and/or supporting provision of unlicensed access policies in a cellular netowrk, according to some embodiments. In various embodiments, some of the elements of the methods shown may be performed concurrently, in a different order than shown, may be substituted for by other method elements, or may be omitted. Additional method elements may also be performed as desired.

Aspects of the method of FIG. 5 may be implemented by a cellular base station, such as a BS 102 illustrated in and described with respect to FIGS. 1, 2, and 4, or more generally in conjunction with any of the computer systems or devices shown in the above Figures, among other devices, as desired. As shown, the method may operate as follows.

In 502, the base station may receive service type information associated with data bearer setup with a wireless UE device. The data bearer setup may, for example, include evolved packet services (EPS) bearer setup between the wireless UE device and a core network entity (e.g., a packet gateway (P-GW)) of a cellular network with which the base station is associated. The data bearer may be set up in response to a user trigger (e.g., from a service executing on the UE device wishing to exchange data) or in response to a network trigger (e.g., from a service that is part of or is connected to the cellular network wishing to exchange data with the UE device), and once set up, may be used to exchange data between the UE device and one or more other endpoints.

The service type information may indicate a service type of a service for which the data bearer is being set up. The service type may be defined in any of various ways, e.g., with as fine or coarse a granularity as desired. Some possible service types could include voice, video, messaging, email, social media, maps, intelligent personal assistant, news, payment, web browser, machine type communication, etc. In some instances different service grades may be defined and provided as service type information; for example, video services could further be differentiated into unidirectional or bidirectional conversational video; unidirectional, broadcast, or multi-cast real-time video; unidirectional on-demand video, etc. Other coarser possible service type definitions could similarly be distinguished into finer service type definitions, if desired, to provide a higher level of granularity to the service type information, which may in turn allow for Quality of Service provided to more closely match the Quality of Service requirements of each service while also providing for efficient use of resources available to the network and the user devices.

Note that in some instances the service type information may be in addition to (e.g., may provide a finer level of granularity than) QoS Class Identifier (QCI) information for the data bearer. Of course, implementations with more broadly defined service types, or even just using QCI information without supplemental service type information, may also be used (e.g., for simplicity of implementation, among various possible reasons), if desired. However, since many QCI categories (e.g., as standardized according to 3GPP TS 23.203) may encompass multiple service types and/or include relatively broadly defined service types, more finely grained service type information may facilitate more precise QoS control.

The service type information may be received from the UE device or from the core network, among various possibilities. For example, the UE device might include service type information in a radio resource control (RRC) message provided to the base station as part of bearer setup, a core network entity might include service type information with a message initiating data bearer setup, etc.

As part of the data bearer setup, a radio bearer may be established between the UE device and the base station, including selecting an access type (e.g., unlicensed or licensed) using which the UE device may exchange data with the cellular network by way of the base station. In 504, the base station may determine radio bearer characteristics based at least in part on the service type information. For example, the base station may determine whether to establish the radio bearer using a licensed frequency band, an unlicensed frequency band, or (e.g., as a split bearer) both a licensed frequency band and an unlicensed frequency band.

The base station may further base its determination of whether to establish the radio bearer to utilize licensed or unlicensed access on policy information received from the core network with which it is associated. For example, the base station may receive policy information specifying one or more service types for which network access using unlicensed frequency bands is not permitted, and/or specifying one or more service types for which network access using unlicensed frequency bands is permitted. In such a case, the base station may determine whether the service type associated with the radio bearer is allowed to use an unlicensed access technique in view of the policy information, and select the radio bearer characteristics accordingly. As will be apparent, other factors may also be considered when determining the radio bearer characteristics; for example, even if the base station does provide an unlicensed access technique (e.g., LTE-LAA secondary access and/or LTE-Wi-Fi aggregation secondary access) and the service type associated with a radio bearer is permitted to use unlicensed access, the base station may still under some circumstances (e.g., based on relative loading of available access techniques, relative radio link conditions, user subscription characteristics and/or preferences, etc.) select a licensed access technique for the radio bearer.

The base station may complete bearer setup with the UE device using the determined access technique(s), and may exchange data with the UE using the established radio bearer. This may include uplink transmissions from the UE device to the base station and/or downlink transmissions from the base station to the UE device.

The base station may also provide some or all of the unlicensed access related policy information to the UE device, in some embodiments. This may allow the UE device to determine and request an appropriate bearer access technique (and/or other bearer characteristics) when setting up a data bearer.

In some instances, the base station may receive a policy update from the core network. The policy update may include new/updated policy information indicating one or more service types for which network access using unlicensed frequency bands is not permitted, and/or one or more service types for which network access using unlicensed frequency bands is permitted; the service types indicated to be permitted (and/or not permitted) may differ in the updated policy information from in the original policy information. Note that if the base station receives such a policy update, the base station may also propagate the policy update (or a relevant portion thereof) to the UE device.

In 506, the base station may provide an indication to the core network when the UE device network access uses unlicensed spectrum. The indication may be provided to an unlicensed access monitoring core network entity, for example. In some instances, the indication may be provided to another core network entity (for example, a mobility management entity (MME), e.g., using an S1 context), which may in turn pass the information received to the unlicensed access monitoring core network entity. The unlicensed access monitoring core network entity may be the same entity from which the unlicensed access policy information is received, or may be a different core network entity.

The indication may include any of various possible information regarding the network access by the UE device. For example, the indication may include information indicating a quantity of data exchanged using unlicensed network access by the UE device. Additionally or alternatively, in various instances, any or all of a time of day (at any desired level of granularity, e.g., from generalizations such as morning/daytime/evening/night to specific hour, minute, second, etc.) associated with data exchanged using unlicensed network access by the UE device, a service type associated with data exchanged using unlicensed network access by the UE device, a proportion of uplink vs. downlink data exchanged using unlicensed network access by the UE device, and/or any of various other characteristics of unlicensed network access by the UE device, may be provided. If desired, further information (with similar or different level of detail) may also be provided with respect to licensed network access by the UE device. Note that the indication may provide the information regarding the network access by the UE device to the core network in a single message or in multiple messages.

Aspects of the method of FIG. 6 may be implemented by a wireless user equipment device, such as a UE 106 illustrated in and described with respect to FIGS. 1-3, or more generally in conjunction with any of the computer systems or devices shown in the above Figures, among other devices, as desired. As shown, the method may operate as follows.

In 602, network policy information regarding unlicensed frequency band usage for a cellular network may be received. As similarly described with respect to FIG. 5, the network policy information may provide network access permission/prohibition information for various possible service types, for example by specifying that network access using unlicensed frequency bands is not permitted for one or more service types.

In 604, the UE device may exchange data with the cellular network in accordance with the network policy. This may include exchanging data associated with a service type for which network access using unlicensed frequency bands is permitted with the cellular network using an unlicensed frequency band, and/or exchanging data associated with a service type for which network access using unlicensed frequency bands is not permitted with the cellular network using a licensed frequency band.

The UE device may be configured to exchange data with the cellular network using an unlicensed frequency band in any of various ways. As one possibility, the UE device may be capable of performing Wi-Fi communication with a wireless access point provided by the cellular network. The Wi-Fi resources provided by the wireless access point may be aggregated under the control of a cellular base station, in some embodiments. As another (additional or alternative) possibility, the UE device may be capable of performing LAA cellular communication with a cellular base station provided by the cellular network.

In 606, the UE device may provide an indication to a core network entity of the cellular network if the UE device exchanges data with the cellular network using an unlicensed frequency band. The indication may be provided to an unlicensed access monitoring core network entity, for example. In some instances, the indication may be provided to another core network entity (for example, a mobility management entity (MME), e.g., using a non-access stratum (NAS) message, or an over-the-air (OTA) or an open mobile alliance device management (OMADM) server, e.g., using an indicator provided by an application layer operating in the UE device), which may in turn pass the information received to the unlicensed access monitoring core network entity. The unlicensed access monitoring core network entity may be the same entity from which the unlicensed access policy information is received, or may be a different core network entity.

The indication may include any of various possible information regarding unlicensed network access by the UE device. For example, similar to the information regarding the network access by the UE device that may be provided from the base station to the core network described previously herein, the indication from the UE device may include information indicating a quantity of data exchanged using unlicensed network access by the UE device. Similarly, any or all of a time of day associated with data exchanged using unlicensed network access by the UE device, a service type associated with data exchanged using unlicensed network access by the UE device, a proportion of uplink vs. downlink data exchanged using unlicensed network access by the UE device, and/or any of various other characteristics of unlicensed network access by the UE device, may be provided. If desired, further information (with similar or different level of detail) may also be provided with respect to licensed network access by the UE device. The indication may provide the information regarding the network access by the UE device to the core network in a single message or in multiple messages.

Note that if desired, the information regarding the network access by the UE device may be provided by the base station (e.g., as illustrated in and described with respect to FIG. 5), or may be provided by the UE device (e.g., as illustrated in and described with respect to FIG. 5), or some (or all) may be provided by the base station and some (or all) may also be provided by the UE device. Any of various such arrangements are possible.

Note that in some instances, the network policy regarding network access using unlicensed frequency bands may be updated. In such a case, the UE device may receive updated network policy information for the cellular network. The updated policy information may, like the original policy information, indicate which service types are permitted and/or are not permitted to use network access techniques that utilize unlicensed spectrum; for example, the updated policy information may specifies that network access using unlicensed frequency bands is not permitted for one or more service types. The service types that are permitted and that are not permitted according to the updated network policy information may be different than the service types permitted and not permitted according to the original network policy information. After receiving such a policy update, the UE device may thereafter exchange data with the cellular network in accordance with the updated policy information.

Aspects of the method of FIG. 7 may be implemented by a cellular network core entity, such as policy control and charging (PCC) entity, or a function within such an entity, such as a LAA function, or more generally in conjunction with any of the computer systems or devices shown in the above Figures, among other devices, as desired. Note further that if desired, portions of the method of FIG. 7 may be implemented by different core network entities; for example, as one possibility, different core network entities may be responsible for storing and distributing policy information regarding network access using unlicensed spectrum and for receiving and storing information regarding usage of unlicensed spectrum for network access by user devices. As shown, the method may operate as follows.

In 702, network policy information regarding unlicensed spectrum usage may be stored. The policy information may include information governing which service types may and/or may not utilize unlicensed spectrum to exchange data with the cellular network. For example, the policy information may include any or all of a list of service types that are not permitted unlicensed access to the cellular network, a list of service types that are permitted unlicensed access to the cellular network, a list of service types that are not permitted licensed access to the cellular network, and/or a list of service types that are permitted licensed access to the cellular network. The policy information may additionally or alternatively include any of various other possible policy information relating to unlicensed spectrum usage, according to various embodiments.

In 704, the policy information may be distributed to network base stations. The policy information may also be distributed to other elements of the radio access network (RAN) of the cellular network, if applicable. The base stations and/or other RAN elements may enforce the network policy regarding unlicensed spectrum usage, for example by establishing radio bearers associated with particular service types using network access techniques in accordance with the network policy.

In certain circumstances, a network operator may determine to update to their policy regarding unlicensed spectrum usage, for example to change which service types are and are not permitted to utilize unlicensed spectrum to access the network. In such a circumstance, an update to the policy information may be received. The updated policy information may in turn be stored and provided to the base stations and/or other RAN elements.

In 706, information regarding network access using an unlicensed frequency band by a UE device may be received. The information may be received from a base station serving the UE device, and/or from the UE device itself, possibly by way of another core network entity (e.g., an MME, OTA server, or OMADM server). As another possibility, the information may be received from another core network entity directly; for example, in some instances an access network discovery and selection function (ANDSF) server may be aware when a UE device selects Wi-Fi as an access technique, and may provide information regarding the Wi-Fi network access by the UE device.

In 708, the information regarding unlicensed frequency band network access by the UE device may be stored. The information may include any of various types of information regarding unlicensed frequency band network access by the UE device, potentially including any or all of a quantity of data exchanged using unlicensed network access by the UE device, a time of day associated with data exchanged using unlicensed network access by the UE device, a service type associated with data exchanged using unlicensed network access by the UE device, a proportion of uplink vs. downlink data exchanged using unlicensed network access by the UE device, and/or any of various other characteristics of unlicensed network access by the UE device. In some instances, the information may further include a similar or different level of detail with respect to licensed network access by the UE device.

Note that such information regarding network access using unlicensed (and possibly also licensed) spectrum may be received and stored with respect to multiple UE devices operating in the cellular network. For example, such information may be stored by a given core network entity or collection of core network entities for all of the user devices operating in the cellular network (e.g., possibly with each of multiple entities storing information for some subset of those user devices operating in the cellular network).

In some embodiments, (e.g., if the entity collecting and storing such information is not already the PCC entity), at least a portion of the information regarding unlicensed (and possibly licensed) frequency band network access may be provided to a PCC entity of the cellular network.

According to some embodiments, providing such information regarding unlicensed (and possibly licensed) network access by UE devices may allow a network operator to differentiate between different types of network usage for charging purposes, which may in turn allow for a greater variety of user subscription plan options and/or allow for finer grained (and potentially more accurate) passthrough of the relative costs of different types of network resource usage, among various possible outcomes.

### FIGS. 8-21—Additional Information

FIGS. 8-21 and the information provided herein below in conjunction therewith are provided by way of example of various considerations and details relating to possible systems in which the methods of FIGS. 5-7 and/or other aspects of this disclosure may be implemented, and are not intended to be limiting to the disclosure as a whole. Numerous variations and alternatives to the details provided herein below are possible and should be considered within the scope of the disclosure.

FIGS. 8-11 illustrate various example unlicensed network access deployment scenarios in which LAA cells operating on unlicensed spectrum may be provided in conjunction with cells operating on licensed spectrum.

In the scenario illustrated in FIG. 8, a macro cell 802 providing network access on one or more licensed carrier frequencies (“F1”) may be coupled to (and may control) a cluster of small cells 806 providing network access on one or more unlicensed carrier frequencies (“F3”). The small cells 806 may not be co-located with the macro cell 802, and may be coupled by way of an ideal backhaul.

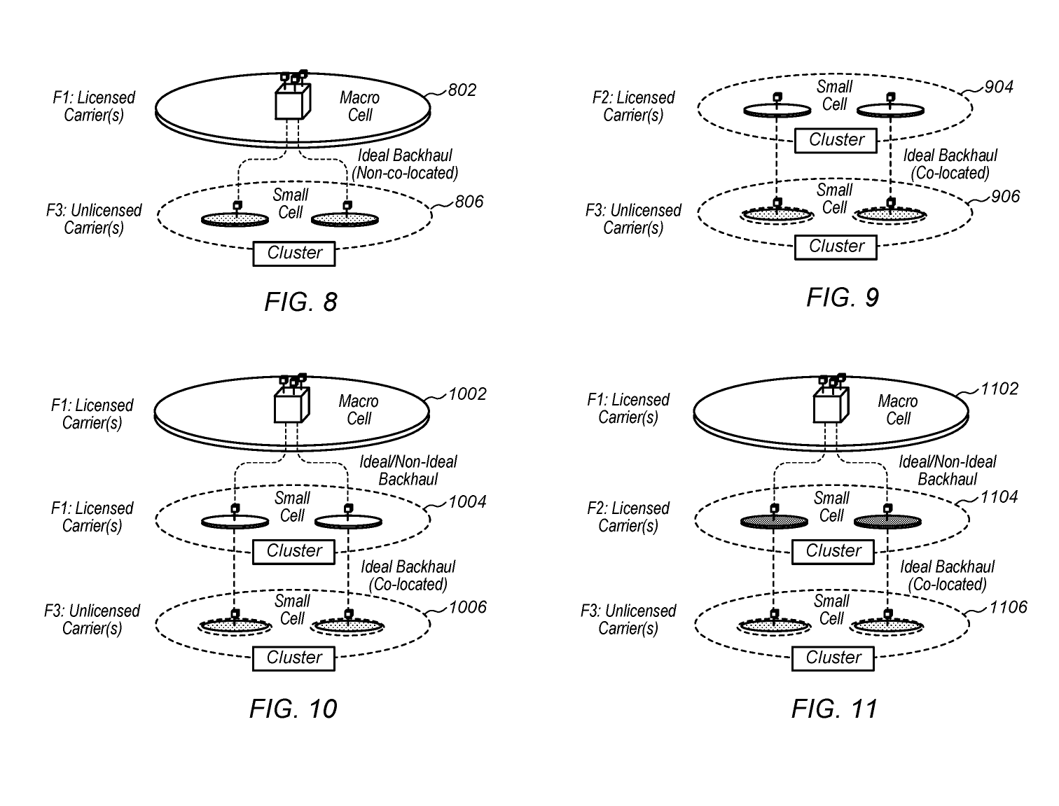

In the scenario illustrated in FIG. 9, a cluster of small cells 904 providing network access on one or more licensed carrier frequencies (“F2”) may be coupled to (and may control) a cluster of small cells 906 providing network access on one or more unlicensed carrier frequencies (“F3”). The small cells 904, 906 may be co-located, and their ‘coupling’ may thus provide an ideal backhaul.

In the scenario illustrated in FIG. 10, a macro cell 1002 providing network access on one or more licensed carrier frequencies (“F1”) may be coupled to (and may control) a cluster of small cells 1004 providing network access on the same licensed carrier frequencies F1. The small cells 1004 may be coupled with the macro cell 1002 by way of an ideal or non-ideal backhaul. The cluster of small cells 1004 providing network access on the licensed carrier frequencies F1 may be coupled to (and may control) a cluster of small cells 1006 providing network access on one or more unlicensed carrier frequencies (“F3”). The small cells 1004, 1006 may be co-located, and their ‘coupling’ may thus provide an ideal backhaul.

In the scenario illustrated in FIG. 11, a macro cell 1102 providing network access on one or more licensed carrier frequencies (“F1”) may be coupled to (and may control) a cluster of small cells 1104 providing network access on one or more different licensed carrier frequencies (“F2”). The small cells 1104 may be coupled with the macro cell 1102 by way of an ideal or non-ideal backhaul. The cluster of small cells 1104 providing network access on the licensed carrier frequencies F2 may be coupled to (and may control) a cluster of small cells 1106 providing network access on one or more unlicensed carrier frequencies (“F3”). The small cells 1104, 1106 may be co-located, and their ‘coupling’ may thus provide an ideal backhaul.

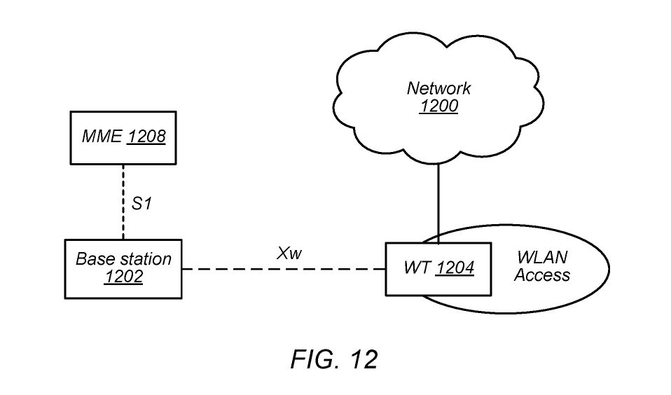

FIG. 12 illustrates an example unlicensed network access deployment scenario in which a wireless terminal 1204 (e.g., a wireless access point) provides WLAN access to a network 1200 on unlicensed spectrum under the control of a base station 1202 (e.g., an eNodeB), which may also provide a cell offering network access using licensed spectrum. The base station 1202 and the wireless terminal 1204 may be communicatively coupled by way of an Xw reference. The base station 1202 may be communicatively coupled to a MME entity 1208 of a cellular network with which it is associated by way of an S1 reference.

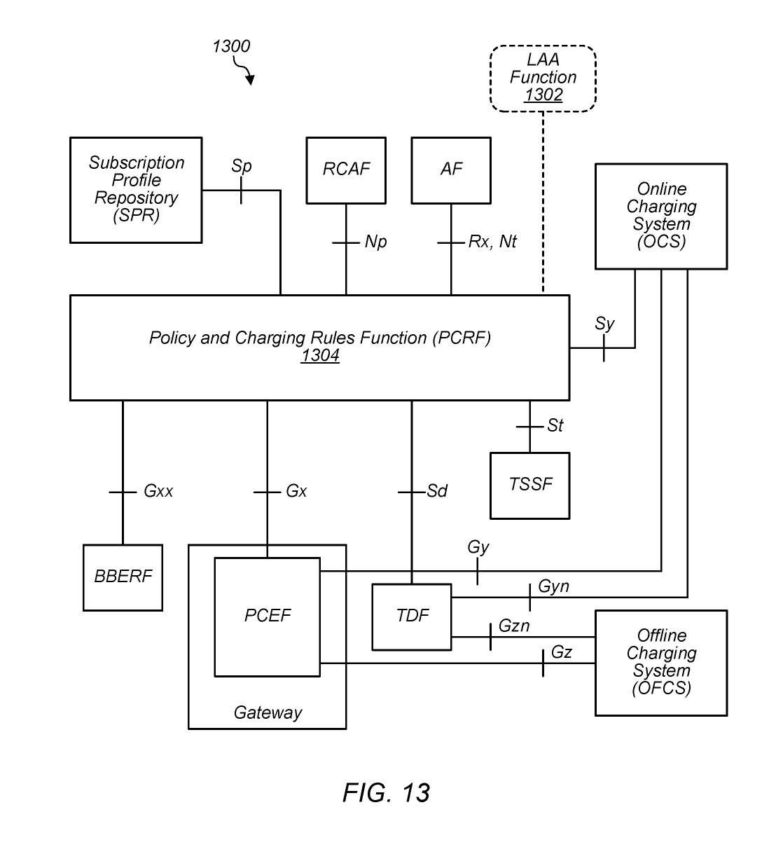

FIG. 13 illustrates an example policy control and charging (PCC) entity 1300 architecture in which a LAA function 1302 may be defined. The LAA function 1302 may provide a logic function for governing LAA operation in a RAN associated with the PCC 1300. Thus, whether the RAN performs LAA operation, and in what manner, may be synchronized with the LAA function 1302. An interface may be provided between the LAA function 1302 and the policy and charging rules function (PCRF) 1304, such that the PCRF 1304 may provide policy information to the LAA function 1302 and the LAA function 1302 may provide policy report updates to the PCRF 1304. It should be noted that as the LAA function 1302 illustrated in FIG. 13 may represent a logical function, and the illustrated architecture of FIG. 13 may generally represent a logical architecture, the LAA function 1302 may be located physically in RAN nodes or in other operator nodes (e.g., co-located), or may be located separately, as desired.

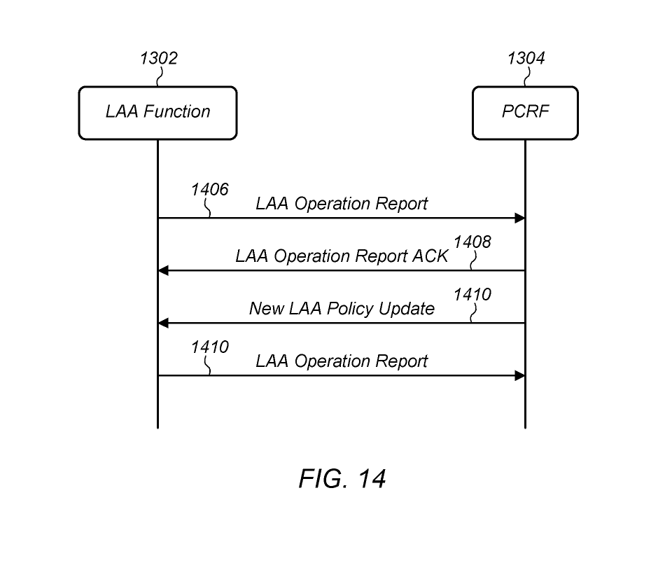

FIG. 14 is a signal flow diagram illustrating an exemplary possible signal flow between a LAA function 1302 and a PCRF 1304 such as illustrated in and described with respect to FIG. 13. As shown, the LAA function 1302 may provide an LAA operation report 1406 to the PCRF 1304. The PCRF 1304 may provide an LAA operation report acknowledgement 1408 to the LAA function 1302 in response to the LAA operation report. At some point, the network operator may update its LAA policy; the PCC rules for LAA access may be configured in the PCRF 1304, and the PCRF 1304 may accordingly provide a new LAA policy update 1410 to the LAA function 1302. Subsequently, the LAA function 1302 may generate and send a new LAA operation report 1410. Similar LAA operation reports, acknowledgements, and policy updates may continue to be exchanged during the course of normal operation, e.g., at specific intervals and/or based on triggering events, among various possibilities, as desired.

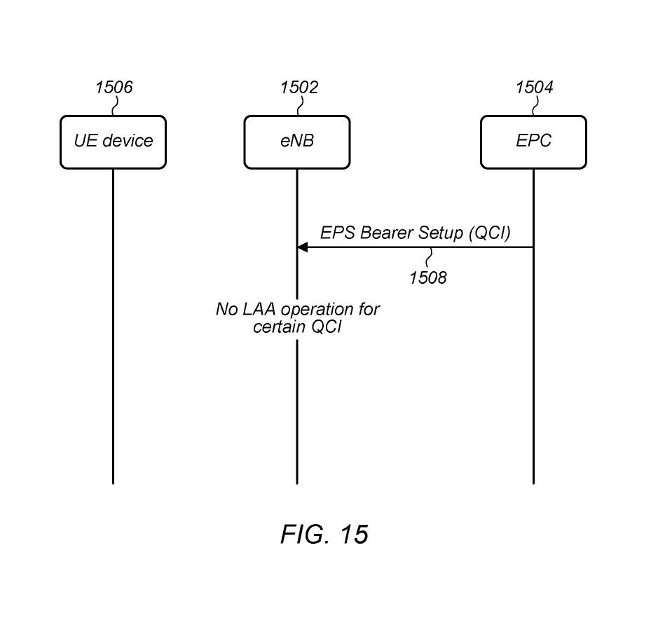

FIGS. 15-17 are signal flow diagrams illustrating possible signal flows between a UE device, an eNB, and an evolved packet core (EPC) supporting implementation of an unlicensed network access policy in exemplary LTE deployment scenarios.

In the scenario illustrated in FIG. 15, as part of EPS bearer setup between a UE device 1506 and an EPC 1504, the EPC 1504 may provide an EPS bearer setup message 1508 to an eNB 1502 serving the UE device 1506. The EPS bearer setup message 1508 may indicate a QCI associated with the EPS bearer. The eNB 1502 may be aware of the network policy regarding LAA network (and/or unlicensed network access generally), e.g., based on receiving unlicensed network access policy information from an LAA function or other core network entity, and so may be able to determine that no LAA operation is permitted for certain QCI values according to the policy. The eNB may perform radio bearer setup for the EPS bearer accordingly, e.g., depending on the QCI value associated with the EPS (and potentially also depending on other considerations).

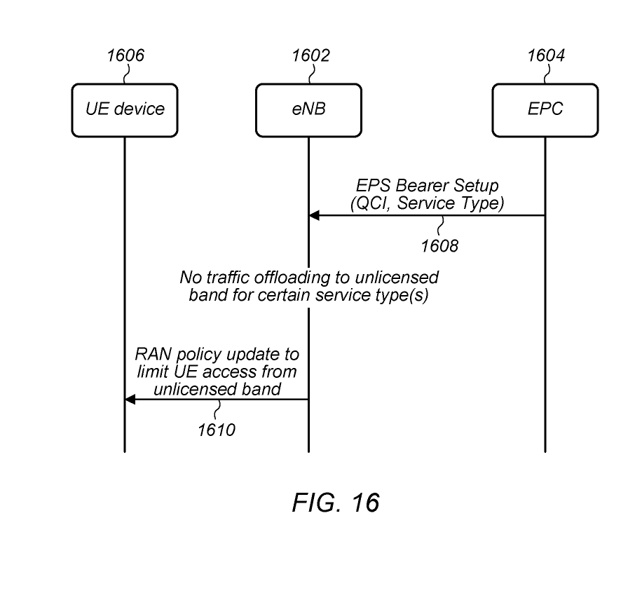

In the scenario illustrated in FIG. 16, as part of EPS bearer setup between a UE device 1606 and an EPC 1604, the EPC 1604 may provide an EPS bearer setup message 1608 to an eNB 1602 serving the UE device 1606. The EPS bearer setup message 1608 may indicate a QCI associated with the EPS bearer, and may also indicate a service type associated with the EPS bearer. The eNB 1602 may be aware of the network policy regarding LAA network access (and/or unlicensed network access generally), e.g., based on receiving unlicensed network access policy information from an LAA function or other core network entity, and so may be able to determine that no traffic offloading to unlicensed spectrum is permitted for certain service types and/or QCI values according to the policy. The eNB 1602 may perform radio bearer setup for the EPS bearer accordingly, e.g., depending on the service type and/or QCI value associated with the EPS (and potentially also depending on other considerations). The eNB 1602 may also provide a RAN policy update message 1610 to the UE device 1606 to indicate that UE access to the network by way of unlicensed spectrum is not permitted, either generally with respect to certain service types and/or QCI values, or specifically in an instance when the EPS bearer is associated with a service type and/or QCI value for which unlicensed access is not permitted according to the network policy.

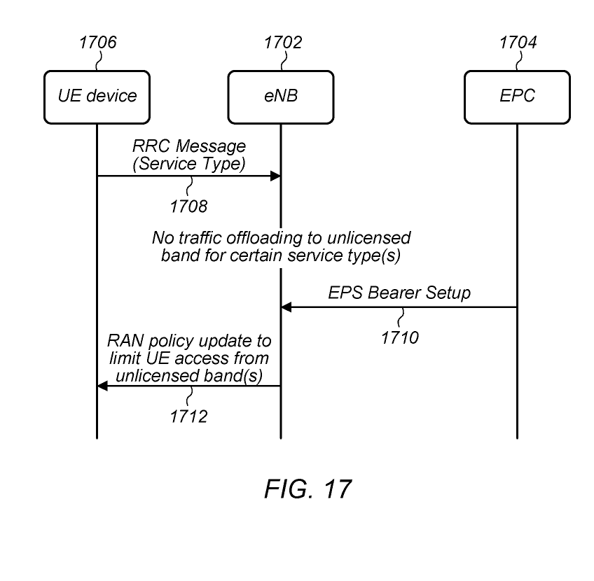

In the scenario illustrated in FIG. 17, a UE device 1706 may provide an RRC message 1708 to an eNB 1702 serving the UE device 1706. The RRC message 1708 may indicate a service type for which EPS bearer setup is requested, e.g., as part of an EPS bearer setup request, or as part of another existing or new RRC message. As in the example scenarios illustrated in FIGS. 15-16, the eNB 1702 may be aware of the network policy regarding LAA network access (and/or unlicensed network access generally), e.g., based on receiving unlicensed network access policy information from an LAA function or other core network entity, and so may be able to determine that no traffic offloading to unlicensed spectrum is permitted for certain service types according to the policy. As part of EPS bearer setup, the EPC 1704 may provide an EPS bearer setup message 1710 to the eNB 1702. The eNB 1702 may perform radio bearer setup for the EPS bearer accordingly, e.g., depending on the service type associated with the EPS (and potentially also depending on other considerations). The eNB 1702 may also provide a RAN policy update message 1712 to the UE device 1706 to indicate that UE access to the network by way of unlicensed spectrum is not permitted, either generally with respect to certain service types, or specifically in an instance when the EPS bearer is associated with a service type for which unlicensed access is not permitted according to the network policy.

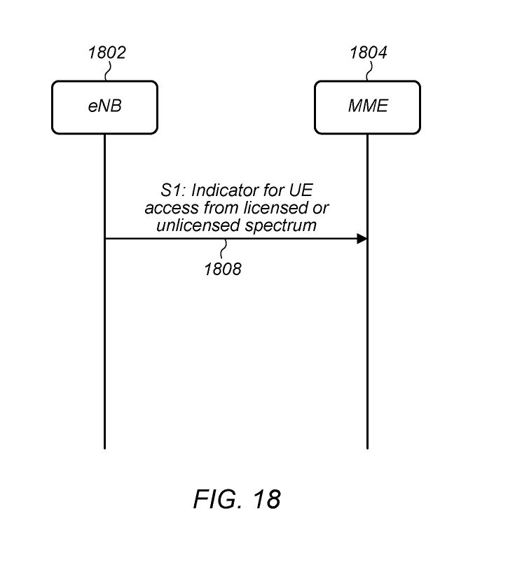

FIGS. 18-21 are signal flow diagrams illustrating possible signal flows supporting monitoring of unlicensed (and possibly also licensed) spectrum usage in exemplary LTE deployment scenarios.

In the scenario illustrated in FIG. 18, an eNB 1802 may provide (e.g., using an S1 context) an indicator 1808 to an MME 1804 to inform the MME 1804 whether UE access is from licensed spectrum or unlicensed spectrum. In such a scenario in which the eNB 1802 reports how UE devices are accessing the RAN to the core network, if the unlicensed access options include a LTE-WLAN aggregation deployment such as illustrated in FIG. 12, an indicator may be provided from a wireless terminal (such as WT 1204 illustrated in FIG. 12) to the eNB 1802 on the Xw interface to inform the eNB 1802 if a UE is being served with Wi-Fi access from the WT.

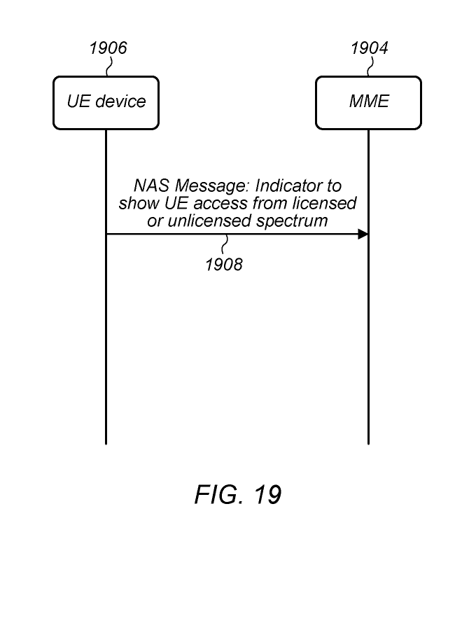

In the scenario illustrated in FIG. 19, a UE device 1906 may provide (e.g., using an NAS message) an indicator 1908 to an MME 1904 to inform the MME 1904 whether the UE device 1906 is accessing the network from licensed spectrum or unlicensed spectrum.

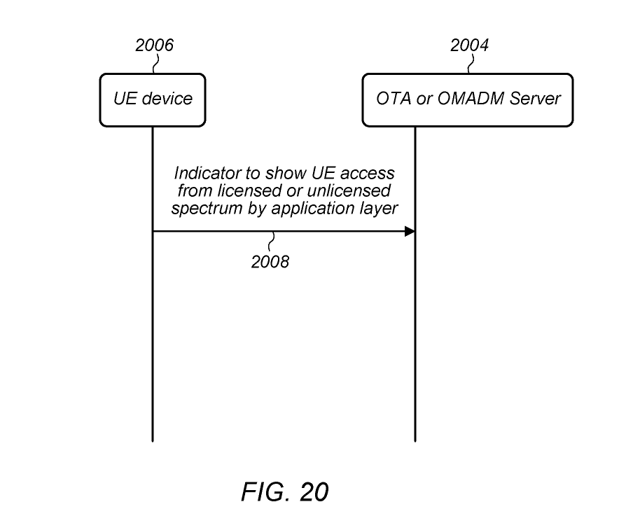

In the scenario illustrated in FIG. 20, a UE device 2006 may provide an indicator 2008 to an OTA or OMADM server 2004 to inform the OTA or OMADM server 2004 whether the UE device 2006 is accessing the network from licensed spectrum or unlicensed spectrum. The indicator 2008 may be a new indicator provided to the OTA or OMADM server 2004 by an application layer operating on the UE device 2006 in such a scenario, at least according to some embodiments.

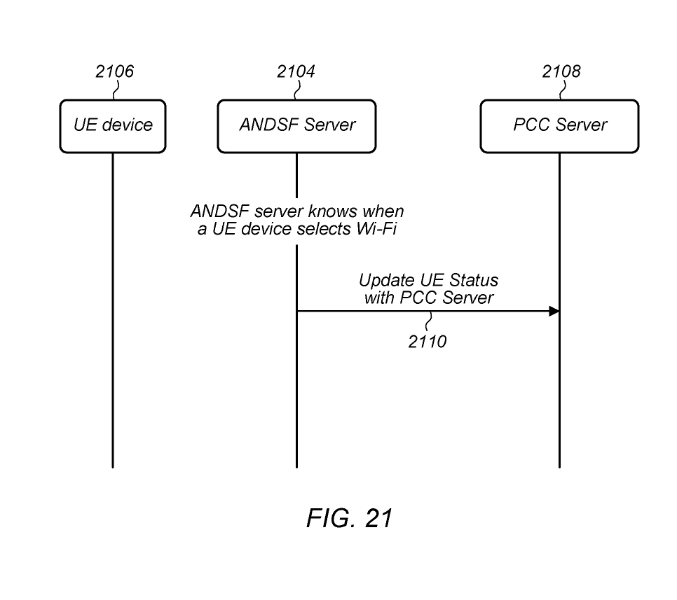

In the scenario illustrated in FIG. 21, an ANDSF server 2104 may be aware (as it may assist in the discovery and selection process) when a UE device 2106 selects Wi-Fi as an access technique. Accordingly, the ANDSF server 2104 may be able to update a PCC server 2108 with an indication 2110 of the status of the UE device 2106 if the UE device 2106 is accessing the network using Wi-Fi communication on unlicensed spectrum. Note that in such a scenario another technique may be used to keep the PCC server 2108 informed about any licensed and other (e.g., LAA) unlicensed network access by the UE device 2106, such as S1 messages passed from an eNB serving the UE device 2106 to an MME, which may in turn report on the network access usage of the UE device 2106 to the PCC server 2108.

In the following further exemplary embodiments are provided.

One set of embodiments may include a base station (BS), including: a radio; and a processing element communicatively coupled to the radio; wherein the radio and the processing element are configured to: receive service type information associated with data bearer setup with a wireless user equipment (UE) device; determine whether to establish a radio bearer of the data bearer using a licensed frequency band or an unlicensed frequency band based at least in part on the service type information; and provide an indication to an unlicensed access monitoring core network entity of a cellular network associated with the base station if the wireless UE device exchanges data with the cellular network using an unlicensed frequency band.

According to some embodiments, determining whether to establish the radio bearer using a licensed frequency band or an unlicensed frequency band based at least in part on the service type information is further based at least in part on unlicensed access policy information received from the core network.

According to some embodiments, the unlicensed access policy information specifies one or more service types for which network access using unlicensed frequency bands is not permitted.

According to some embodiments, the service type information is received from the wireless UE device.

According to some embodiments, the service type information is received from the core network.

According to some embodiments, the radio and the processing element are further configured to: provide policy information to the wireless UE device specifying one or more service types for which network access using unlicensed frequency bands is not permitted.

A further set of embodiments may include a wireless user equipment (UE) device comprising: a radio; and a processing element communicatively coupled to the radio; wherein the radio and the processing element are configured to: receive network policy information for a cellular network, wherein the network policy information specifies that network access using unlicensed frequency bands is not permitted for one or more service types; exchange data with the cellular network using one or more licensed or unlicensed frequency bands in accordance with the network policy.

According to some embodiments, the radio and the processing element are further configured to: provide an indication to a core network entity of the cellular network if the wireless UE device exchanged the data with the cellular network using an unlicensed frequency band.

According to some embodiments, the indication comprises a non access stratum (NAS) message provided to a mobility management entity of the cellular network.

According to some embodiments, the indication is provided to an over-the-air (OTA) or an open mobile alliance device management (OMADM) server of the cellular network by an application layer operating in the wireless UE device.

According to some embodiments, the wireless UE device is configured to exchange data with the cellular network using an unlicensed frequency band by performing one or more of: Wi-Fi communication with a wireless access point provided by the cellular network; or license assisted access (LAA) cellular communication with a cellular base station provided by the cellular network.

According to some embodiments, to exchange data with the cellular network using one or more licensed or unlicensed frequency bands in accordance with the network policy, the radio and the processing element are further configured to: exchange data associated with a service type for which network access using unlicensed frequency bands is permitted with the cellular network using an unlicensed frequency band; and exchange data associated with a service type for which network access using unlicensed frequency bands is not permitted with the cellular network using a licensed frequency band.

According to some embodiments, the radio and the processing element are further configured to: receive updated network policy information for the cellular network, wherein the updated network policy information also specifies that network access using unlicensed frequency bands is not permitted for one or more service types, wherein the one or more service types not permitted according to the updated network policy information are different than the one or more service types not permitted according to the original network policy information; and exchange data with the cellular network using one or more licensed or unlicensed frequency bands in accordance with the updated network policy based on receiving the updated network policy information.

Yet another set of embodiments may include an apparatus configured to provide a core network function of a network, comprising a processing element configured to: store policy information regarding whether to permit data flows of a plurality of possible service types to use unlicensed frequency bands to access the network; and provide the policy information to a plurality of base stations that provide radio access to the network.

According to some embodiments, the processing element is further configured to: receive an update to the policy information; store the updated policy information; and provide the updated policy information to the plurality of base stations.

According to some embodiments, the processing element is further configured to: receive information regarding network access using an unlicensed frequency band by a wireless user equipment (UE) device; and store information regarding the unlicensed frequency band network access by the wireless UE device.

According to some embodiments, the information regarding network access using the unlicensed frequency band by the wireless UE device comprises information indicating a quantity of data exchanged using unlicensed network access by the wireless UE device.

According to some embodiments, the information regarding network access using the unlicensed frequency band by the wireless UE device comprises information indicating a time of day associated with data exchanged using unlicensed network access by the wireless UE device.

According to some embodiments, the information regarding network access using the unlicensed frequency band by the wireless UE device comprises information indicating a service type associated with data exchanged using unlicensed network access by the wireless UE device.

According to some embodiments, the processing element is further configured to: provide at least a portion of the information regarding the unlicensed frequency band network access by the wireless UE device to a policy and charging rules function of the network.

Embodiments of the present disclosure may be realized in any of various forms. For example some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A base station (BS), comprising:
a radio; and
a processing element communicatively coupled to the radio;
wherein the radio and the processing element are configured to:
receive service type information associated with data bearer setup with a wireless user equipment (UE) device;
determine whether to establish a radio bearer of the data bearer using a licensed frequency band or an unlicensed frequency band based at least in part on the service type information; and
provide an indication to an unlicensed access monitoring core network entity of a cellular network associated with the base station if the wireless UE device exchanges data with the cellular network using an unlicensed frequency band.

2. The BS of claim 1,
wherein determining whether to establish the radio bearer using a licensed frequency band or an unlicensed frequency band based at least in part onthe service type information is further based at least in part on unlicensed access policy information received from the core network.

3. The BS of claim 2,
wherein the unlicensed access policy information specifies one or more service types for which network access using unlicensed frequency bands is not permitted.

4. The BS of claim 1,
wherein the service type information is received from the wireless UE device.

5. The BS of claim 1,
wherein the service type information is received from the core network.

6. The BS of claim 1, wherein the radio and the processing element are further configured to:
provide policy information to the wireless UE device specifying one or more service types for which network access using unlicensed frequency bands is not permitted.

7. A wireless user equipment (UE) device comprising:
a radio; and
a processing element communicatively coupled to the radio;
wherein the radio and the processing element are configured to:
receive network policy information for a cellular network, wherein the network policy information specifies that network access using unlicensed frequency bands is not permitted for one or more service types; and
exchange data with the cellular network using one or more licensed or unlicensed frequency bands in accordance with the network policy.

8. The wireless UE device of claim 7, wherein the radio and the processing element are further configured to:
provide an indication to a core network entity of the cellular network if the wireless UE device exchanged the data with the cellular network using an unlicensed frequency band.

9. The wireless UE device of claim 8,
wherein the indication comprises a non access stratum (NAS) message provided to a mobility management entity of the cellular network.

10. The wireless UE device of claim 8,
wherein the indication is provided to an over-the-air (OTA) or an open mobile alliance device management (OMADM) server of the cellular network by an application layer operating in the wireless UE device.

11. The wireless UE device of claim 7, wherein the wireless UE device is configured to exchange data with the cellular network using an unlicensed frequency band by performing one or more of:
Wi-Fi communication with a wireless access point provided by the cellular network; or
License assisted access (LAA) cellular communication with a cellular base station provided by the cellular network.

12. The wireless UE device of claim 7, wherein to exchange data with the cellular network using one or more licensed or unlicensed frequency bands in accordance with the network policy, the radio and the processing element are further configured to:
exchange data associated with a service type for which network access using unlicensed frequency bands is permitted with the cellular network using an unlicensed frequency band; and
exchange data associated with a service type for which network access using unlicensed frequency bands is not permitted with the cellular network using a licensed frequency band.

13. The wireless UE device of claim 7, wherein the radio and the processing element are further configured to:
receive updated network policy information for the cellular network, wherein the updated network policy information also specifies that network access using unlicensed frequency bands is not permitted for one or more service types, wherein the one or more service types not permitted according to the updated network policy information are different than the one or more service types not permitted according to the original network policy information; and
exchange data with the cellular network using one or more licensed or unlicensed frequency bands in accordance with the updated network policy based on receiving the updated network policy information.

14. An apparatus configured to provide a core network function of a network, comprising a processing element configured to:
store policy information regarding whether to permit data flows of a plurality of possible service types to use unlicensed frequency bands to access the network; and
provide the policy information to a plurality of base stations that provide radio access to the network.

15. The apparatus of claim 14, wherein the processing element is further configured to:
receive an update to the policy information;
store the updated policy information; and
provide the updated policy information to the plurality of base stations.

16. The apparatus of claim 14, wherein the processing element is further configured to:
receive information regarding network access using an unlicensed frequency band by a wireless user equipment (UE) device; and
store information regarding the unlicensed frequency band network access by the wireless UE device.

17. The apparatus of claim 16,
wherein the information regarding network access using the unlicensed frequency band by the wireless UE device comprises information indicating a quantity of data exchanged using unlicensed network access by the wireless UE device.

18. The apparatus of claim 16,
wherein the information regarding network access using the unlicensed frequency band by the wireless UE device comprises information indicating a time of day associated with data exchanged using unlicensed network access by the wireless UE device.

19. The apparatus of claim 16,
wherein the information regarding network access using the unlicensed frequency band by the wireless UE device comprises information indicating a service type associated with data exchanged using unlicensed network access by the wireless UE device.

20. The apparatus of claim 16, wherein the processing element is further configured to:
provide at least a portion of the information regarding the unlicensed frequency band network access by the wireless UE device to a policy and charging rules function of the network.
